(19) United States
(12) Patent Application Publication
(10) Pub. No.: US 2009/0119180 A1
(43) Pub. Date: May 7, 2009

(54) Food on demand channel and interactive website commercial

(76) Inventors: Robert J. Moravsky, Plantsville, CT (US); Kelly P. Moravsky, Plantsville, CT (US)

Correspondence Address: Daniel N. Smith, 15 Church Street, Salem, MA, 01970, US

(21) Appl. No.: 12/150,768

(22) Filed: Apr. 30, 2008

Related U.S. Application Data
(60) Provisional application No. 61/001,423, filed on Nov. 1, 2007.

(51) Int. Cl. G06Q 30/00

(52) U.S. Cl. 705/15

(57) ABSTRACT

A system and method for providing an online mechanism for ordering goods via computer terminal or television system which further provides a series of menus that may be accessed through a system of menus or even through such convention as an interactive commercial. The system and method further allow the user to choose form genre of goods or a listing of providers which can be goods specific or general to the field of endeavor.

### CROSS REFERENCE TO RELATED APPLICATION

This application claims the benefit of U.S. Provisional Application No. 61/001,423 filed on Nov. 1, 2007, the contents of which are incorporated herein by reference.

### FIELD OF THE INVENTION

The present invention relates generally to the field of culinary arts and food ordering systems and in particular an interactive food channel, which can be reached via web sites and upon which commercials can be placed.

### REFERENCES

In general within the art, descriptions of online product ordering and specifically online food ordering systems and their various related elements can be found in U.S. Pat. Nos. 5,845,263 set forth by Camaisa; 5,991,739 set forth by Cupps et al.; US 2005/0114150 set forth by Franklin; US 2006/0218043 A1 set forth by Rosenzweig; and US 2007/0203801 A1 set forth by Istfan.

### BACKGROUND OF INVENTION

In the past, when a person placed an order for food over the telephone without a menu in front of them, the person was most likely not aware of all of the existing options. This same rationale may be extended to the bigger picture, where the user ordering from a telephone book or other such mechanism can never be fully up to date regarding all the current choices, as the yearly updates offered render traditional telephone books antiquated. Obviously, the advent of such an atmosphere can create confusion for the customer and restaurant employee alike, especially at peak business hours when employees regularly contend with a high volume of in person sales as well as call orders.

Further, under normal telephone ordering procedures, customers are typically not made aware of the price of their order until finalization of the entire order. Such a situation may cause a person to spend more than they intended, but they may feel too embarrassed to cancel one or more of the ordered items. Ordering by phone is also a very rushed process. The employee has work to do and cannot recite the entire menu to the customer and the customer wants to place their order as quickly as possible, while still being aware of all of their options regarding price, size, dressings and anything else offered by the facility.

With the advent of computers and networking mechanisms, including the world-wide web, or internet, systems have been developed to allow consumers to purchase items on line. What is needed is a system that would enable the user to place an order for food from the television or computer

What is needed is a system that would enable the user to place an order for food from the television or computer which further provides differing methods to access the system. What is needed is a convenient method of ordering would provide a much-needed visual dimension to the ordering process.

What is needed is a system where customers would be made more aware of all of the prices and options, as customers would be able to view and scroll through the entire menus of the differing subscribing restaurants. What is needed is a system which would enable customers to sit on their couch and locate a specific restaurant and place an order.

What is needed is a system that would eliminate the confusion and uncertainty normally associated with ordering goods over the phone, as the customer could scroll through every option including meals, appetizers, condiments, beverages and any other service provided by the restaurant. What is needed is a system that would facilitate the task of the restaurant employee, as said employee would not have to answer as many telephone calls as the customer would already be well informed regarding the availability of goods at any given time. Finally what is needed is a progressive, new concept which could be made available on any television or computer and could be ordered from the comfort of a person's home, or even from a hotel or motel room.

In summary, investigation of these disclosed devices illustrates that presently, there is no single device known in the art or combination thereof that meets the requirements of a single protection system that allows the use to order products, and preferably food.

### SUMMARY OF THE INVENTION

The instant invention, as illustrated herein, is clearly not anticipated, rendered obvious, or even present in any of the prior art mechanisms, either alone or in any combination thereof. The instant invention imparts a novel interactive ordering system, which may be utilized through a home computer and television terminal, adapted to compensate for the aforementioned drawbacks and limitations would afford significant improvement to numerous useful applications. Thus the several embodiments of the instant invention are illustrated herein.

One embodiment of the subject invention is an interactive food order system comprising: at least one remote user computer terminal comprising access to the Internet (World Wide Web), said user computer terminal further comprising an interactive software program wherein real time changes to an order are registered upon said at least one remote user terminal; a network computer system comprising a data base wherein said database comprises at least one menu for access by said at least one remote user computer terminal; at least two individual restaurant computer terminals comprising access to the Internet (World Wide Web); said at least two restaurant computer terminal further comprising an interactive software program wherein real time changes to an order are registered upon the user terminal; wherein said at least two individual restaurant computer terminals are disposed in restaurants featuring an at least two differing genres of cuisine; and, a data base sorting mechanism wherein information is sorted and catalogued by said at least two differing genres of cuisine.

Another embodiment of the subject invention is an interactive food order system wherein a user may access said interactive food ordering system from an apparatus selected from the group consisting of a cable television system and a satellite television system.

A further embodiment of the subject invention is an interactive food order system, wherein a user may access said interactive food order system from an internal system selected from the group consisting of a food television channel, a food on demand function of video on demand and a food on demand interactive commercial.

Another embodiment of the subject invention is an interactive food order system, wherein said plurality of restaurant computer terminals are aligned in communication and wherein information from the individual restaurants routes to said at least two differing genres of cuisines for sorting.

An even further embodiment of the subject invention is an interactive food order system, wherein said at least two individual restaurant computer terminals comprises a plurality of restaurant computer terminals.

A further embodiment of the subject invention is an interactive food order system, wherein said at least two differing genres of cuisine further comprise a plurality of genres of cuisine.

Another embodiment of the subject invention is an interactive food order system, wherein said plurality of genres of cuisine may be selected from the group consisting of fast food, gourmet dining and nation of food origin.

An embodiment of the subject invention is a food ordering system comprising a multi-purpose ordering routine comprising: a series of remote user computer terminals comprising internet access, said user computer terminals further comprising an interactive software program wherein real time changes to an order are registered upon said at least one remote user terminal; a network computer system comprising a data base wherein said database comprises at least one menu for access by said at least one remote user computer terminal; at series of individual restaurant computer terminals comprising Internet access; said at least two restaurant computer terminal further comprising an interactive software program wherein real time changes to an order are registered upon the user terminal; wherein said at least two individual restaurant computer terminals are disposed in restaurants featuring an at least two differing genres of cuisine; a data base sorting mechanism wherein information is sorted and catalogued by said at least two differing genres of cuisine; and, wherein a user may access said interactive food order system from an internal system selected from the group consisting of a food television channel, a food on demand function of video on demand and a food on demand interactive commercial.

Another embodiment of the subject invention is a food ordering system, wherein a user may access said interactive food ordering system from an apparatus selected from the group consisting of a cable television system and a satellite television system.

A further embodiment of the subject invention is a food ordering system, wherein said plurality of restaurant computer terminals are aligned in communication and wherein information from the individual restaurants routes to said at least two differing genres of cuisines for sorting.

An even further embodiment of the subject invention is a food ordering system, wherein said at least two individual restaurant computer terminals comprises a plurality of restaurant computer terminals.

An embodiment of the subject invention is a food ordering system, wherein said at least two differing genres of cuisine further comprise a plurality of genres of cuisine.

Another embodiment of the subject invention is a method of ordering goods, wherein said plurality of genres of cuisine may be selected from the group consisting of fast food, gourmet dining and nation of food origin.

A further embodiment of the subject invention is a method of ordering goods consisting of the steps of: providing a series of interactive television systems wherein a user may interface with software and an interactive terminal; generating a system of menus disposed to enter a goods ordering system by way an interactive function displayed on said interactive television system; generating a system of menus disposed for selection of a primary language for user interaction; generating a system of menus for selecting a method for ordering; processing a selection of said user in order to communicate the selected order to the selected provider; generating a confirmation that said selected provider has received said selected order; generating a finalization of transaction in order for said selected provider to deliver said selected goods; and, wherein said system of menus for selecting a method for ordering comprises a menus selected form the group consisting of genres of product and specific entity providing product.

Another embodiment of the subject invention is a method of ordering goods, wherein a user may access said system of menus from an apparatus selected from the group consisting of a cable television system and a satellite television system.

An embodiment of the subject invention is a method of ordering goods, wherein a user may access said system of menus through an internal system selected from the group consisting of a food television channel, a food on demand function of video on demand and a food on demand interactive commercial.

Another embodiment of the subject invention is a method of ordering goods, wherein said series of interactive television systems are aligned in communication and wherein information from individual of said series of interactive television systems routes to a series of sorting files.

The Food On Demand system depicts a unique method and system for ordering food through a specific television channel, an interactive commercial (placed on any other channel to provide a shortcut to a specific part of Food On Demand, such as an advertisement for a particular food item), or internet readout display, eliminating the tedious and hassled process of ordering over the phone. The Food On Demand menu could be incorporated into the interactive options already in place for cable services. The user would simply use the normal remote control or computer mouse to select the proper menu where they would begin ordering food. The customer could view all of the restaurants in the delivery vicinity or could narrow their choice down by selecting certain categories, such as fast food, Italian, Chinese, pizza and any other type of food. The customer could even access the phone number of the location if they choose to. Food On Demand would provide the customer with a complete menu, prices for each item, pictures/mini-commercials featuring the food they are interested in and a variety of other options so the customer can order exactly what they want. Food On Demand would enable the customer to browse every list to facilitate the ordering process, including choice of salads, beverages, appetizers and specials. When the customer has placed their order, a representative from the restaurant would contact the customer and ensure their order has been placed and give an approximate time of delivery. In addition, interactive commercials, from participating restaurants, will provide shortcuts to items advertised.

It is an object of the instant invention to provide a system that enables the user to place an order for food from the television or computer which further provides differing methods to access the system. It is an object of the instant invention to provide a convenient method of ordering would provide a much-needed visual dimension to the ordering process.

It is an object of the instant invention to provide a system which renders customers more aware of all of the prices and options, as customers would be able to view and scroll through the entire menus of the differing subscribing restaurants. It is an object of the instant invention to provide a system which enables customers to sit on their couch and locate a specific restaurant and place an order.

It is an object of the instant invention to provide a system that that eliminates the confusion and uncertainty normally associated with ordering goods over the phone, as the customer could scroll through every option including meals, appetizers, condiments, beverages and any other service provided by the restaurant. It is an object of the instant invention to provide a system designed to facilitate the task of the restaurant employee, as said employee would not have to answer as many telephone calls as the customer would already be well informed regarding the availability of goods at any given time. Finally, it is an object of the instant invention to provide a progressive, new concept, available on any television or computer and wherefrom goods could be ordered from the comfort of a person's home, or even from a hotel or motel room.

The instant Food On Demand system would enable the user to place an order for food from the television or computer, and using differing methods to access the system. This convenient method of ordering would provide a much-needed visual dimension to the ordering process. Customers would be made more aware of all of the prices and options, as they would be able to look at and scroll through the restaurant's entire menu. Customers could sit on their couch and locate a specific restaurant and place an order.

This progressive, new concept could be made available on any television or computer and could be ordered from the comfort of a person's home, or even from a hotel or motel room. Food On Demand would eliminate the confusion and uncertainty from ordering over the phone, as the customer could scroll through every option of meals, appetizers, condiments, beverages and any other service provided by the restaurant. Food On Demand would also make the task of the restaurant easier, as they would not have to answer so many phone calls and the customer would already be well informed of what is and is not available in their facility.

Accordingly, an improved system for order food, or other products via the internet and television, accompanying enhancements and the component elements are herein described, which achieve these objectives, plus other advantages and enhancements.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

There has thus been outlined, rather broadly, the more important features of the apparatus for protection of an improved system for ordering food in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated preferred embodiments of the invention. Other features and advantages of the present invention will become apparent from the following description of the preferred embodiment(s), taken in conjunction with the accompanying drawings, which illustrate, by way of example, the principles of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates the manner in which a commercial is selected and the viewer is then immediately taken to the Food On Demand channel, where the advertised food will be displayed for instant purchase.

FIG. 2 illustrates that upon selecting what was advertised during the interactive commercial, the customer may then access the restaurant's Main Menu to order other items;.

FIG. 3 illustrates how the process then continues as described in detailed description in FIGS. 4-5;

FIG. 4 illustrates the screens for a typical ordering sequence including initial Welcome, selection of a type of food from the Type of Food Menu, selection of a restaurant from the Fast Food Menu, and selection of type food from the Selected Restaurant Menu; and

FIG. 5 continues along the sequence of ordering by next illustrating selection from the Drink Menu, finalization on the Your Order Menu, the total payment due displayed on the Your Order Total Menu and the exit on the Thank You Menu.

FIGS. 6 through 8 represent flowcharts further illustrating the normal ordering sequence for a food on demand cable and food on demand satellite system, illustrating the menus that a user follows in order to complete an entire selection and sale.

### DETAILED DESCRIPTION OF THE PREFERRED EMBODIMENTS

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

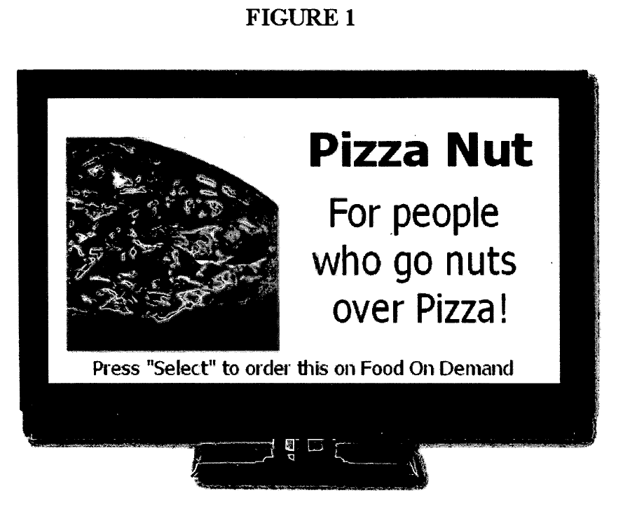

FIGS. 1-3 illustrate, by way of example, not to be limited to any individual embodiment, one version of the visual interactive menu options for ordering with Food On Demand, as would be viewed by a customer at a terminal. The following Figures illustrate how Food On Demand can be activated during a commercial on television for the purposes affording an extremely quick order transaction. As illustrated in FIG. 1, once the commercial is selected, the viewer is then immediately taken to the Food On Demand channel, where the advertised food will be displayed for instant purchase. This represents a shortcut wherein the customer to avoid surfing any extra menus at the Food On Demand channel.

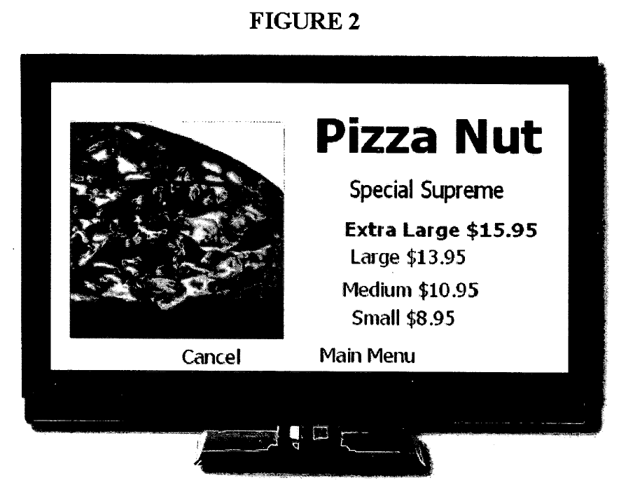

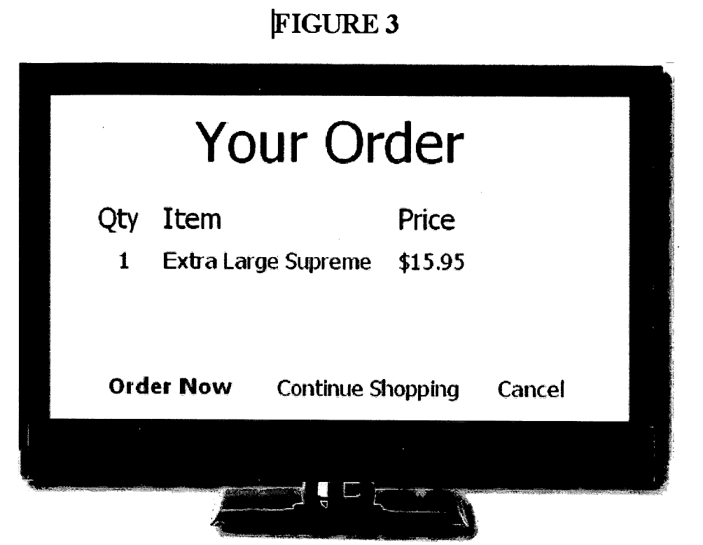

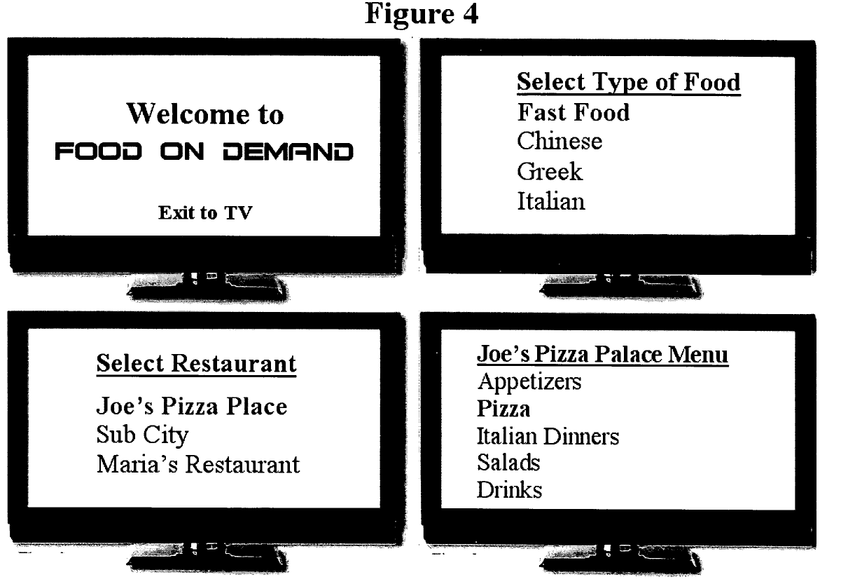

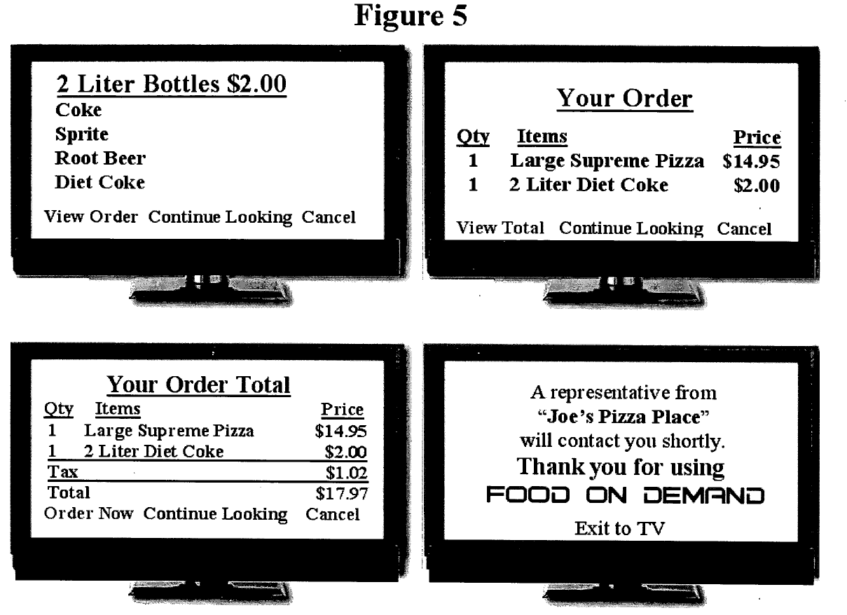

As illustrated in FIG. 2, upon selecting what was advertised during the interactive commercial, the customer may then access the restaurant's Main Menu to order other items. As illustrated in FIG. 3 the process then continues as described in detailed description in previous FIGS. 4 through 5.

FIG. 4 illustrates the screens for a typical ordering sequence including initial Welcome, selection of a type of food from the Type of Food Menu, selection of a restaurant from the Fast Food Menu, and selection of type food from the Selected Restaurant Menu; and

FIG. 5 continues along the sequence of ordering by next illustrating selection from the Drink Menu, finalization on the Your Order Menu, the total payment due displayed on the Your Order Total Menu and the exit on the Thank You Menu.

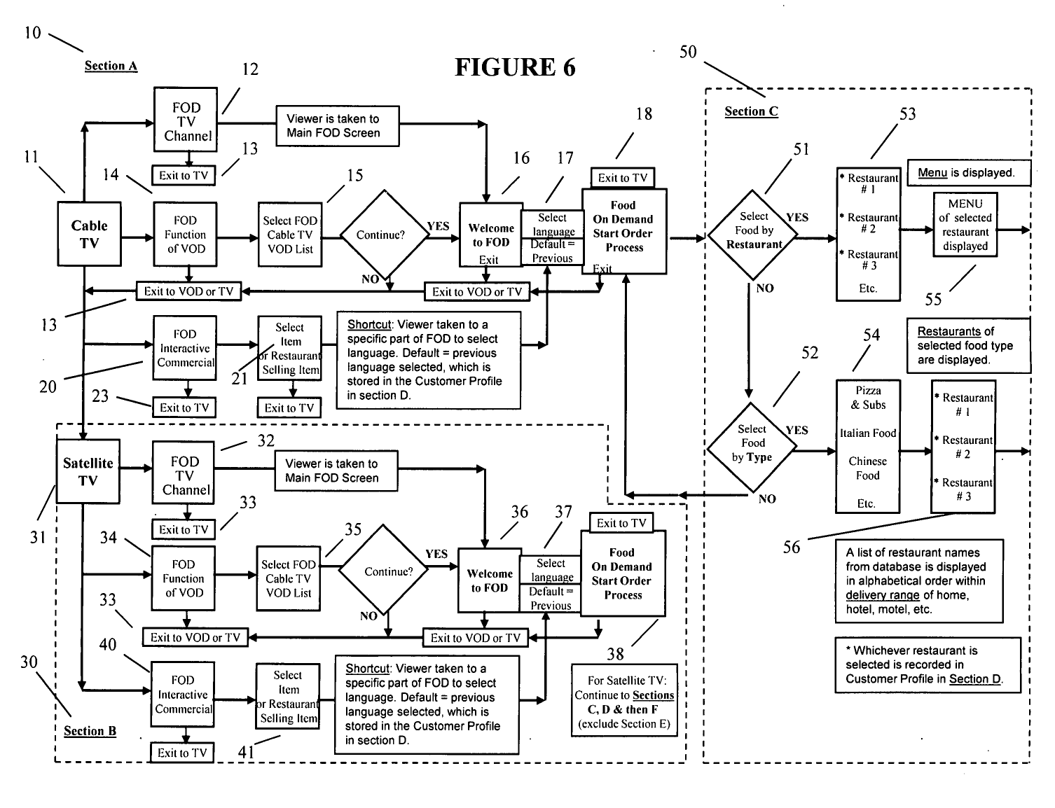

Further, FIGS. 6 through 8 represent flowcharts further illustrate the normal ordering sequence for a food on demand cable and food on demand satellite system, illustrating the menus that a user follows in order to complete an entire selection and sale.

FIG. 6 illustrates the how a user may enter the system via cable television 11, in Section A 10 or satellite television 31 in Section B 30. Section A 10 illustrates the steps a user takes including accessing, from cable television 11, the FOD TV Channel 12 which relays the user to the main FOD screen and the user is prompted at the Welcome to Food on Demand menu 16. At any time, the user is allowed to exit the program from any of these menus and be routed back to the regular cable television menus, via an exit to TV button 13. From the Welcome to Food on Demand menu 16, the user is then allowed to select a language 17 and thus commence the order process, outlined in Section C 50.

In a second method of entering the FOD system from cable television, a similar evolution occurs when a user accesses from the FOD function of the VOD 14 and selects FOD 15 and thus routed to the Welcome to Food on Demand menu 16. The user is then allowed to select a language 17 and thus commence the order process, outlined in Section C 50.

In a third method of entering the FOD system from cable television, a similar evolution occurs when a user accesses from the FOD function form an FOD Interactive Commercial 20, and a user may then select the specific restaurant or a specific item 21 from the advertisement. The user is then routed to the Welcome to Food on Demand menu 16. The user is then allowed to select a language 17 and thus commence the order process, outlined in Section C 50. At any time, the user is allowed to exit the program from any of these menus and be routed back to the regular cable television menus, via an exit to TV button 23.

Further in FIG. 6, as illustrated in Section B 30, the user is afforded very similar choices when the user enters from a Satellite television system 31, Section B 30 illustrates the steps a user takes including accessing, from Satellite television 31, the FOD TV Channel 32 which relays the user to the main FOD screen and the user is prompted at the Welcome to Food on Demand menu 36. At any time, the user is allowed to exit the program from any of these menus and be routed back to the regular satellite television menus, via an exit to TV button 13. From the Welcome to Food on Demand menu 36, the user is then allowed to select a language 37 and thus commence the order process, outlined in Section C 50.

In a second method of entering the FOD system from satellite television, a similar evolution occurs when a user accesses from the FOD function of the VOD 34 and selects FOD 35 and thus routed to the Welcome to Food on Demand menu 36. The user is then allowed to select a language 37 and thus commence the order process, outlined in Section C 50.

In a third method of entering the FOD system from satellite television, a similar evolution occurs when a user accesses from the FOD function form an FOD Interactive Commercial 40, and a user may then select the specific restaurant or a specific item 41 from the advertisement. The user is then routed to the Welcome to Food on Demand menu 36. The user is then allowed to select a language 37 and thus commence the order process, outlined in Section C 50. At any time, the user is allowed to exit the program from any of these menus and be routed back to the regular satellite television menus, via an exit to TV button 33.

In Section C 50, the user can now select Food by Restaurant 51 and thus be linked to a series of restaurants 53 and then a MENU of the selected restaurant 55 will be displayed. Taking a different direction, the user can choose Food by Type 52, and be routed to a series of food types 54 including such variations as Fast Food, Gourmet, Pizza and Subs, or even ethic categories such as Italian or Chinese. Then, the user will be linked to a series of restaurants 56 within the respective food.

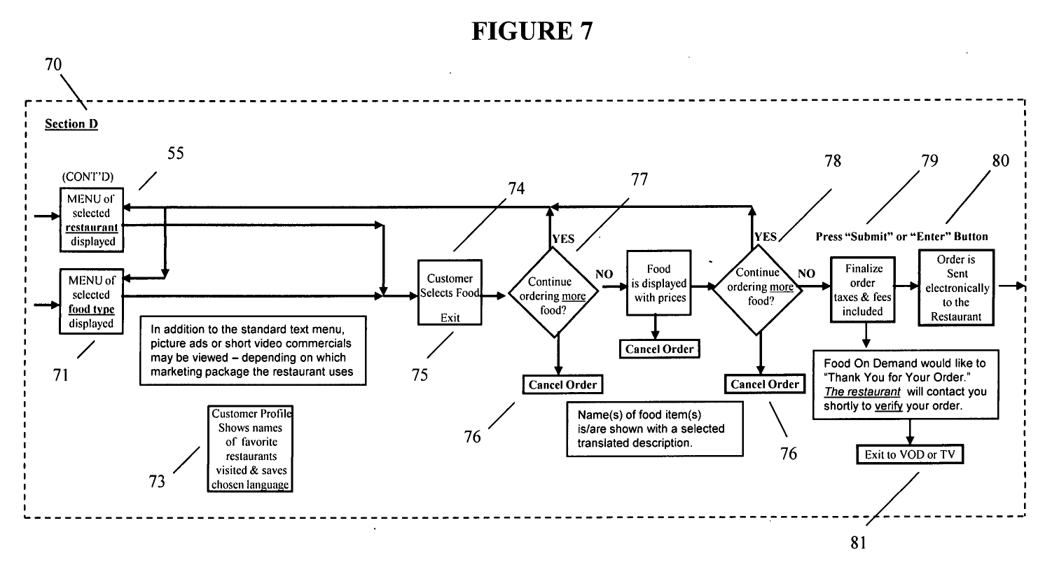

In FIG. 7, Section D 70, the user continues on from either the MENU of the selected restaurant 55 or the next menu in the originally MENU from the of selected food type now evolves to the menu from the restaurant of the selected food type 71. From either of these menus, the user is then prompted to select the desired food 74 or exit 75. Next, the user can then either continue ordering more food 77, cancel the order 76 and again exit or continue on and have the food ordered displayed with prices 78. Next, the user can again order more food 78, or can then finalize the order with taxes and fees included 79. Once finalized, the order is sent electronically to the restaurant of choice 80 and then the user is issued a Thank You for Order message and allowed to exit to the VOD or television systems 81.

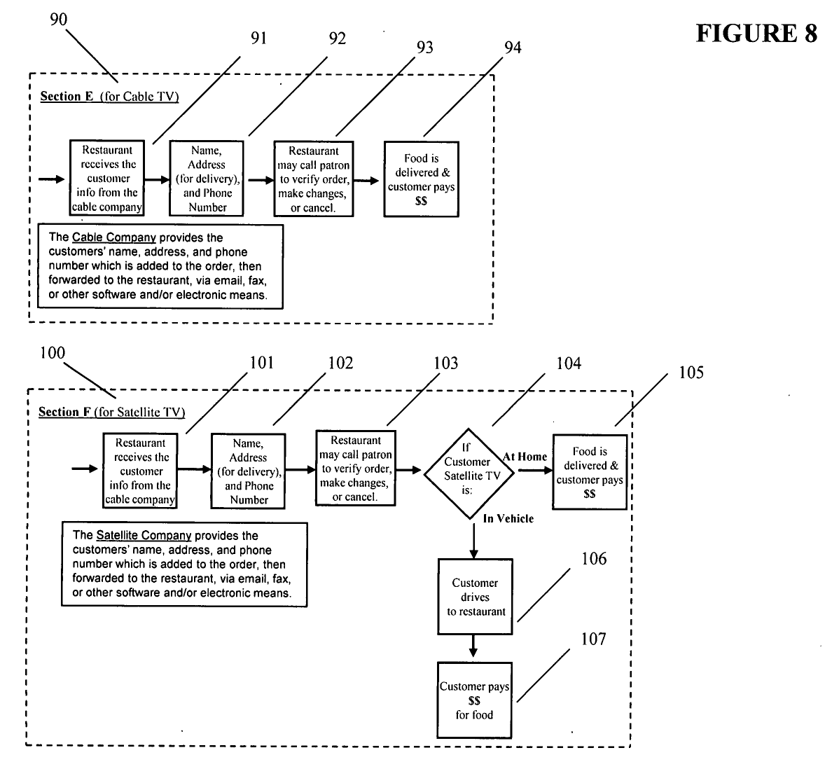

FIG. 8 illustrates what occurs when the restaurant receives an order from the Cable TV system (in Section E 90) or the Satellite TV system (in Section F 100). In Section E 90, the evolution is shown to completion including Restaurant receipt of the customer information from the cable company 91, Name, Address (for delivery) and Phone Number 92, Verification, changes or cancellation by the Restaurant (if required) 93 and final delivery and customer payment 94.

In Section F 100, the evolution is shown to completion including Restaurant receipt of the customer information from the cable company 101, Name, Address (for delivery) and Phone Number 102, Verification, changes or cancellation by the Restaurant (if required) 103 and finally, routing as to whether the customer has satellite TV 104 at home and the delivery and customer payment 105 or located in a vehicle, and thus the customer is picking the food up 106 final delivery and customer payment 106.

As an aside feature, a database may be utilized to generate a customer profile 73 cataloging a customer favorite foods and restaurants.

What is claimed is:

1. An interactive food order system comprising:
at least one remote user computer terminal comprising access to the Internet (World Wide Web), said user computer terminal further comprising an interactive software program wherein real time changes to an order are registered upon said at least one remote user terminal;
a network computer system comprising a data base wherein said database comprises at least one menu for access by said at least one remote user computer terminal;
at least two individual restaurant computer terminals comprising access to the Internet (World Wide Web); said at least two restaurant computer terminal further comprising an interactive software program wherein real time changes to an order are registered upon the user terminal; wherein said at least two individual restaurant computer terminals are disposed in restaurants featuring an at least two differing genres of cuisine; and,
a data base sorting mechanism wherein information is sorted and catalogued by said at least two differing genres of cuisine.

2. The interactive food order system of claim 1 wherein a user may access said interactive food ordering system from an apparatus selected from the group consisting of a cable television system and a satellite television system.

3. The interactive food order system of claim 2, wherein a user may access said interactive food order system from an internal system selected from the group consisting of a food television channel, a food on demand function of video on demand and a food on demand interactive commercial.

4. The interactive food order system of claim 3, wherein said plurality of restaurant computer terminals are aligned in communication and wherein information from the individual restaurants routes to said at least two differing genres of cuisines for sorting.

5. The interactive food order system of claim 4, wherein said at least two individual restaurant computer terminals comprises a plurality of restaurant computer terminals.

6. The interactive food order system of claim 5, wherein said at least two differing genres of cuisine further comprise a plurality of genres of cuisine.

7. The interactive food order system of claim 6, wherein said plurality of genres of cuisine may be selected from the group consisting of fast food, gourmet dining and nation of food origin.

8. A food ordering system comprising a multi-purpose ordering routine comprising:
a series of remote user computer terminals comprising internet access, said user computer terminals further comprising an interactive software program wherein real time changes to an order are registered upon said at least one remote user terminal;
a network computer system comprising a data base wherein said database comprises at least one menu for access by said at least one remote user computer terminal;
at series of individual restaurant computer terminals comprising Internet access; said at least two restaurant computer terminal further comprising an interactive software program wherein real time changes to an order are registered upon the user terminal; wherein said at least two individual restaurant computer terminals are disposed in restaurants featuring an at least two differing genres of cuisine;
a data base sorting mechanism wherein information is sorted and catalogued by said at least two differing genres of cuisine; and,
wherein a user may access said interactive food order system from an internal system selected from the group consisting of a food television channel, a food on demand function of video on demand and a food on demand interactive commercial.

9. The food ordering system comprising a multi-purpose ordering routine of claim 8, wherein a user may access said interactive food ordering system from an apparatus selected from the group consisting of a cable television system and a satellite television system.

10. The food ordering system comprising a multi-purpose ordering routine of claim 9, wherein said plurality of restaurant computer terminals are aligned in communication and wherein information from the individual restaurants routes to said at least two differing genres of cuisines for sorting.

11. The interactive food order system of claim 10, wherein said at least two individual restaurant computer terminals comprises a plurality of restaurant computer terminals.

12. The interactive food order system of claim 11, wherein said at least two differing genres of cuisine further comprise a plurality of genres of cuisine.

13. The interactive food order system of claim 12, wherein said plurality of genres of cuisine may be selected from the group consisting of fast food, gourmet dining and nation of food origin.

14. A method of ordering goods consisting of the steps of:
providing a series of interactive television systems wherein a user may interface with software and an interactive terminal;
generating a system of menus disposed to enter a goods ordering system by way an interactive function displayed on said interactive television system;
generating a system of menus disposed for selection of a primary language for user interaction;
generating a system of menus for selecting a method for ordering;
processing a selection of said user in order to communicate the selected order to the selected provider;
generating a confirmation that said selected provider has received said selected order;
generating a finalization of transaction in order for said selected provider to deliver said selected goods; and,
wherein said system of menus for selecting a method for ordering comprises a menus selected form the group consisting of genres of product and specific entity providing product.

15. The method of ordering goods of claim 14 wherein a user may access said system of menus from an apparatus selected from the group consisting of a cable television system and a satellite television system.

16. The method of ordering goods of claim 15 wherein a user may access said system of menus through an internal system selected from the group consisting of a food television channel, a food on demand function of video on demand and a food on demand interactive commercial.

17. The method of ordering goods of claim 16 wherein said series of interactive television systems are aligned in communication and wherein information from individual of said series of interactive television systems routes to a series of sorting files.
